(19) United States
(12) Patent Application Publication
(10) Pub. No.: US 2020/0310859 A1
(43) Pub. Date: Oct. 1, 2020

(54) SYSTEM AND METHOD FOR AN OBJECT LAYER

(71) Applicant: Nutanix, Inc., San Jose, CA (US)

(72) Inventors: Karan Gupta, San Jose, CA (US); Pavan Konka, San Jose, CA (US); Gowtham Alluri, San Jose, CA (US); Dheer Moghe, Bangalore (IN); Arth Patel, Vadodara (IN); Sudheer Ponnemkunnath Rammohan, Hosur (IN); Roger Liao, San Jose, CA (US); Ajay Raghavan, San Jose, CA (US)

(73) Assignee: Nutanix, Inc., San Jose, CA (US)

(21) Appl. No.: 16/664,747

(22) Filed: Oct. 25, 2019

Related U.S. Application Data
(60) Provisional application No. 62/827,742, filed on Apr. 1, 2019.
(60) Provisional application No. 62/880,590, filed on Jul. 30, 2019.
(60) Provisional application No. 62/891,217, filed on Aug. 23, 2019.

(51) Int. Cl. G06F 9/455; G06F 9/50

(52) U.S. Cl. CPC G06F 9/45558; G06F 9/5027; G06F 3/067; G06F 2009/45579; G06F 9/5061

(57) ABSTRACT

An illustrative embodiment disclosed herein is an apparatus including a processor having programmed instructions to send an application programming interface (API) write request to a first virtual machine (VM) on a first node to write an object, receive a response to the API write request including a physical disk location of a physical disk to which the object is written, wherein the physical disk is located on a second node, and using the physical disk location, send an API read request to a second VM on the second node to read the object.

### CROSS-REFERENCE TO RELATED APPLICATION

This application is related to and claims priority under 35 U.S. § 119(e) from U.S. Patent Application No. 62/827,742, filed Apr. 1, 2019, titled “SYSTEM AND METHOD FOR AN OBJECT LAYER,” U.S. Patent Application No. 62/880,590, filed Jul. 30, 2019, titled “SYSTEM AND METHOD FOR AN OBJECT LAYER,” and U.S. Patent Application No. 62/891,217, filed Aug. 23, 2019, titled “SYSTEM AND METHOD FOR AN OBJECT LAYER,” the entire contents of which are incorporated herein by reference for all purposes.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The virtual machines utilize the hardware resources of the underlying host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, the present-day virtual computing systems have limitations due to their configuration and the way they operate.

### SUMMARY

Aspects of the present disclosure relate generally to a virtualization environment, and more particularly to a system and method for using an object layer.

An illustrative embodiment disclosed herein is an apparatus including a processor having programmed instructions to send an application programming interface (API) write request to a first virtual machine (VM) on a first node to write an object, receive a response to the API write request including a physical disk location of a physical disk to which the object is written, wherein the physical disk is located on a second node, and using the physical disk location, send an API read request to a second VM on the second node to read the object.

Another illustrative embodiment disclosed herein is a non-transitory computer readable storage medium having instructions stored thereon that, upon execution by a processor, causes the processor to perform operations including sending an application programming interface (API) write request to a first virtual machine (VM) on a first node to write an object, receiving a response to the API write request including a physical disk location of a physical disk to which the object is written, wherein the physical disk is located on a second node, and using the physical disk location, sending an API read request to a second VM on the second node to read the object.

Another illustrative embodiment disclosed herein is a computer-implemented method including sending, by a processor, an application programming interface (API) write request to a first virtual machine (VM) on a first node to write an object, receiving, by the processor, a response to the API write request including a physical disk location of a physical disk to which the object is written, wherein the physical disk is located on a second node, and using the physical disk location, sending, by the processor, an API read request to a second VM on the second node to read the object.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 is an example block diagram of a virtual computing system, in accordance with some embodiments of the present disclosure.

FIG. 2 is an example block diagram of an object storage environment for writing and reading objects, in accordance with some embodiments of the present disclosure.

FIG. 3 is an example method for serving an object write request, in accordance with some embodiments of the present disclosure.

FIG. 4 is an example method for serving an object read request, in accordance with some embodiments of the present disclosure.

FIG. 5 is an example method for pipelining, in accordance with some embodiments of the present disclosure.

FIG. 6 is an example method for uploading objects using shadow buckets, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

In some storage systems, storage is performed using either block storage protocols such as Internet Small Computer Systems Interface (iSCSI) or file storage protocols such as network file system (NFS). Such systems are not capable of achieving inter-cluster or inter-data center communication. In some virtualized storage systems, storage is performed using objects and application programming interfaces (APIs) made up of hypertext transfer protocol (HTTP) requests. Such APIs include representational state transfer (REST) APIs. In such systems, a storage layer can handle the storage and an object layer can handle front end requests. However, even such virtualized systems do not expose the functionality of internal storage system to the object layer. Thus, neither of these systems leverage the functionality of the internal storage system to improve performance or scalability of multi-cluster and multi-data center systems. For example, in these systems, there are a significant amount of network hops to serve an I/O request. Furthermore, in these systems, the storage layer is responsible for doing the metadata look up for the object associated with the I/O request. The virtual machines (VMs) on the storage layer serving an I/O request do not have the capacity to hold metadata cache for objects, resulting in more network hops. Furthermore, the VMs on the storage layer typically are a bottleneck for I/O requests. Thus, there is a technical challenge of reducing the latency and network resource usage associated with object storage I/O requests. What is needed is a system and method for exposing the storage layer to the object layer.

The disclosure described herein is directed to systems and methods for exposing a storage layer to an object layer through a process called paravirtualization. In one embodiment, in response to serving a write request, resources allocated to the storage layer will send a location hint to the object layer. The location hint may be a physical disk location. On a next read request for the same object, resources allocated to the object layer can read directly from the node where the object is located.

The present disclosure describes embodiments that exposes storage level functionality of multi-cluster and multi-datacenter systems using APIs. As such, the present disclosure describes embodiments that may result in performing I/O requests with less network hops than in conventional systems. The present disclosure describes embodiments that enable resources allocated to the object layer to do the metadata lookup for the object to be read. Thus, the I/O requests can be spread across multiple VMs in the object layer and each VM can be responsible for a portion of the metadata cache. The fewer network hops and the distributed metadata cache reduces the latency of I/O requests, frees up available network resources, and lowers power consumption of the nodes housing the network resources.

Some embodiments of the present disclosure include a system and method for pipelining object storage. In some embodiments, resources allocated to the object layer receive an object request and determine whether to partition the object into chunks. In some embodiments, responsive to determining that the object is to be partitioned into chunks, the resources allocated to the object layer sends the chunks to the storage layer to be stored in the underlying storage. Advantageously, in some embodiments, the system and method for pipelining object storage reduces memory requirements for the I/O components in the object and storage layers in serving I/O requests, reduces the latency in serving the I/O requests, and increases the throughput in serving the I/O requests.

Some embodiments of the present disclosure include a system and method for uploading objects using shadow buckets. In some embodiments, a multipart object is uploaded to an object store as individual objects. The individual objects are stored in a shadow bucket, causing the individual objects to be hidden from a client. Responsive to all of the individual objects being uploaded, the multipart object is finalized and the individual objects are moved to a standard bucket, causing the individual objects to be visible to the client. Advantageously, in some embodiments, the system and method hide in-flight/transit updates from a client, enabling a better user experience. Furthermore, in some embodiments, the system and method leverages the object store infrastructure and existing APIs and, thus, does not require custom CPU, storage, or network resources.

### Object Virtualization Technology and Environment

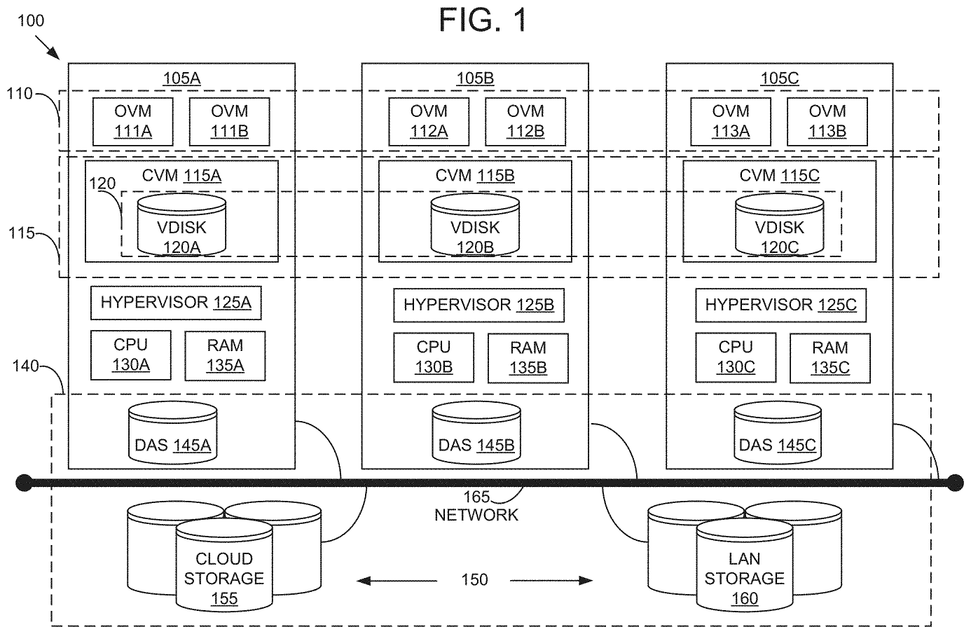

Referring now to FIG. 1, a virtual computing system 100 is shown, in accordance with some embodiments of the present disclosure. The virtual computing system 100 includes a plurality of nodes, such as a first node 105A, a second node 105B, and a third node 105C. The nodes may be collectively referred to herein as “nodes 105.” Each of the nodes 105 may also be referred to as a “host” or “host machine.” The first node 105A includes an object virtual machine (“OVMs”) 111A and 111B (collectively referred to herein as “OVMs 111”), a controller virtual machine (“CVM”) 115A, and a hypervisor 125A. Similarly, the second node 105B includes OVMs 112A and 112B (collectively referred to herein as “OVMs 112”), a CVM 115B, and a hypervisor 125B, and the third node 105C includes OVMs 113A and 113B (collectively referred to herein as “OVMs 113”), a CVM 115C, and a hypervisor 125C. The OVMs 111, 112, and 113 may be collectively referred to herein as “OVMs 110.” The CVMs 115A, 115B, and 115C may be collectively referred to herein as “CVMs 115.” The nodes 105 are connected to a network 165.

The virtual computing system 100 also includes a storage pool 140. The storage pool 140 may include network-attached storage (NAS) 150 and direct-attached storage (DAS) 145A, 145B, and 145C (collectively referred to herein as DAS 145). The NAS 150 is accessible via the network 165 and, in some embodiments, may include cloud storage 155, as well as local area network (“LAN”) storage 160. In contrast to the NAS 150, which is accessible via the network 165, each of the DAS 145A, the DAS 145B, and the DAS 145C includes storage components that are provided internally within the first node 105A, the second node 105B, and the third node 105C, respectively, such that each of the first, second, and third nodes may access its respective DAS without having to access the network 165.

The CVM 115A may include one or more virtual disks (“vdisks”) 120A, the CVM 115B may include one or more vdisks 120B, and the CVM 115C may include one or more vdisks 120C. The vdisks 120A, the vdisks 120B, and the vdisks 120C are collectively referred to herein as “vdisks 120.” The vdisks 120 may be a logical representation of storage space allocated from the storage pool 140. Each of the vdisks 120 may be located in a memory of a respective one of the CVMs 115. The memory of each of the CVMs 115 may be a virtualized instance of underlying hardware, such as the RAMs 135 and/or the storage pool 140. The virtualization of the underlying hardware is described below.

In some embodiments, the CVMs 115 may be configured to run a distributed operating system in that each of the CVMs 115 run a subset of the distributed operating system. In some such embodiments, the CVMs 115 form one or more Nutanix Operating System (“NOS”) cluster. In some embodiments, the one or more NOS clusters include greater than or fewer than the CVMs 115. In some embodiments, each of the CVMs 115 run a separate, independent instance of an operating system. In some embodiments, the one or more NOS clusters may be referred to as a storage layer. In some embodiments, one or more NOS clusters (herein referred to as NOS) host, have access to, and/or include one or more components of the storage pool 140.

In some embodiments, the OVMs 110 form an OVM cluster. OVMs of an OVM cluster may be configured to share resources with each other. The OVMs in the OVM cluster may be configured to access storage from the NOS cluster using one or more of the vdisks 120 as a storage unit. The OVMs in the OVM cluster may be configured to run software-defined object storage service, such as Nutanix Buckets™. The OVM cluster may be configured to create buckets, add objects to the buckets, and manage the buckets and objects. In some embodiments, the OVM cluster include greater than or fewer than the OVMs 110.

Multiple OVM clusters and/or multiple NOS clusters may exist within a given virtual computing system (e.g., the virtual computing system 100). The one or more OVM clusters may be referred to as a client layer or object layer. The OVM clusters may be configured to access storage from multiple NOS clusters. Each of the OVM clusters may be configured to access storage from a same NOS cluster. A central management system, such as Prism Central, may manage a configuration of the multiple OVM clusters and/or multiple NOS clusters. The configuration may include a list of OVM clusters, a mapping of each OVM cluster to a list of NOS clusters from which the OVM cluster may access storage, and/or a mapping of each OVM cluster to a list of vdisks that the OVM cluster owns or has access to.

Each of the OVMs 110 and the CVMs 115 is a software-based implementation of a computing machine in the virtual computing system 100. The OVMs 110 and the CVMs 115 emulate the functionality of a physical computer. Specifically, the hardware resources, such as CPU, memory, storage, etc., of a single physical server computer (e.g., the first node 105A, the second node 105B, or the third node 105C) are virtualized or transformed by the respective hypervisor (e.g. the hypervisor 125A, the hypervisor 125B, and the hypervisor 125C), into the underlying support for each of the OVMs 110 and the CVMs 115 that may run its own operating system, a distributed operating system, and/or applications on the underlying physical resources just like a real computer. By encapsulating an entire machine, including CPU, memory, operating system, storage devices, and network devices, the OVMs 110 and the CVMs 115 are compatible with most standard operating systems (e.g. Windows, Linux, etc.), applications, and device drivers. Thus, each of the hypervisors 125 is a virtual machine monitor that allows the single physical server computer to run multiple instances of the OVMs 110 (e.g. the OVM 111) and at least one instance of a CVM 115 (e.g. the CVM 115A), with each of the OVM instances and the CVM instance sharing the resources of that one physical server computer, potentially across multiple environments. By running the multiple instances of the OVMs 110 on a node of the nodes 105, multiple workloads and multiple operating systems may be run on the single piece of underlying hardware computer to increase resource utilization and manage workflow.

The hypervisors 125 of the respective nodes 105 may be configured to run virtualization software, such as, ESXi from VMWare, AHV from Nutanix, Inc., XenServer from Citrix Systems, Inc., etc. The virtualization software on the hypervisors 125 may be configured for managing the interactions between the respective OVMs 110 (and/or the CVMs 115) and the underlying hardware of the respective nodes 105. Each of the CVMs 115 and the hypervisors 125 may be configured as suitable for use within the virtual computing system 100.

In some embodiments, each of the nodes 105 may be a hardware device, such as a server. For example, in some embodiments, one or more of the nodes 105 may be an NX-1000 server, NX-3000 server, NX-5000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the nodes 105 may be another type of hardware device, such as a personal computer, an input/output or peripheral unit such as a printer, or any type of device that is suitable for use as a node within the virtual computing system 100. In some embodiments, the virtual computing system 100 may be part of a data center.

The first node 105A may include one or more central processing units (“CPUs”) 130A, the second node 105B may include one or more CPUs 130B, and the third node 105C may include one or more CPUs 130C. The CPUs 130A, 130B, and 130C are collectively referred to herein as the CPUs 130. The CPUs 130 may be configured to execute instructions. The instructions may be carried out by a special purpose computer, logic circuits, or hardware circuits of the first node 105A, the second node 105B, and the third node 105C. The CPUs 130 may be implemented in hardware, firmware, software, or any combination thereof. The term “execution” is, for example, the process of running an application or the carrying out of the operation called for by an instruction. The instructions may be written using one or more programming language, scripting language, assembly language, etc. The CPUs 130, thus, execute an instruction, meaning that they perform the operations called for by that instruction.

The first node 105A may include one or more random access memory units (“RAM”) 135A, the second node 105B may include one or more RAM 135B, and the third node 105C may include one or more RAM 135C. The RAMs 135A, 135B, and 135C are collectively referred to herein as the RAMs 135. The CPUs 130 may be operably coupled to the respective one of the RAMs 135, the storage pool 140, as well as with other elements of the respective ones of the nodes 105 to receive, send, and process information, and to control the operations of the respective underlying node. Each of the CPUs 130 may retrieve a set of instructions from the storage pool 140, such as, from a permanent memory device like a read only memory (“ROM”) device and copy the instructions in an executable form to a temporary memory device that is generally some form of random access memory (“RAM”), such as a respective one of the RAMs 135. One of or both of the ROM and RAM be part of the storage pool 140, or in some embodiments, may be separately provisioned from the storage pool. The RAM may be stand-alone hardware such as RAM chips or modules. Further, each of the CPUs 130 may include a single stand-alone CPU, or a plurality of CPUs that use the same or different processing technology.

Each of the DAS 145 may include a variety of types of memory devices. For example, in some embodiments, one or more of the DAS 145 may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the NAS 150 may include any of a variety of network accessible storage (e.g., the cloud storage 155, the LAN storage 160, etc.) that is suitable for use within the virtual computing system 100 and accessible via the network 165. The storage pool 140, including the NAS 150 and the DAS 145, together form a distributed storage system configured to be accessed by each of the nodes 105 via the network 165, one or more of the OVMs 110, one or more of the CVMs 115, and/or one or more of the hypervisors 125.

Each of the nodes 105 may be configured to communicate and share resources with each other via the network 165, including the respective one of the CPUs 130, the respective one of the RAMs 135, and the respective one of the DAS 145. For example, in some embodiments, the nodes 105 may communicate and share resources with each other via one or more of the OVMs 110, one or more of the CVMs 115, and/or one or more of the hypervisors 125. One or more of the nodes 105 may be organized in a variety of network topologies.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Although three of the plurality of nodes (e.g., the first node 105A, the second node 105B, and the third node 105C) are shown in the virtual computing system 100, in other embodiments, greater than or fewer than three nodes may be used. Likewise, although only two of the OVMs are shown on each of the first node 105A (e.g. the OVMs 111), the second node 105B, and the third node 105C, in other embodiments, greater than or fewer than two OVMs may reside on some or all of the nodes 105.

It is to be understood again that only certain components and features of the virtual computing system 100 are shown and described herein. Nevertheless, other components and features that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

### Object Layer

Objects are collections of unstructured data that includes the object data and object metadata describing the object or the object data. In some embodiments, the object metadata includes one or more unique identifiers. A bucket is a logical construct that is used to store objects in an underlying storage technology. In some embodiments, the bucket includes references to object data associated with the bucket. In some embodiments, the bucket includes a data structure that maps object identifiers to locations in the underlying storage technology where the objects associated with the object identifiers are stored. In some embodiments, the bucket has policies that determine how the objects associated with the bucket are managed, updated, and replicated, among others. The objects can be associated to the buckets by users and/or the policies. The buckets can be partitioned into bucket partitions.

Buckets or Object Storage Service (OSS), is a layered service being built over NOS. OSS uses the power of the NOS offering and builds an efficient and scalable object store service on top. Clients (e.g. client devices or client applications) read and write objects to the OSS and use GET and PUT calls for read and write operations. In some embodiments, an entire object is written and partial writes, appends or overwrites are not permitted. For reads and writes, data flows through OSS components before being stored in NOS storage. OSS is herein referred to as the object layer.

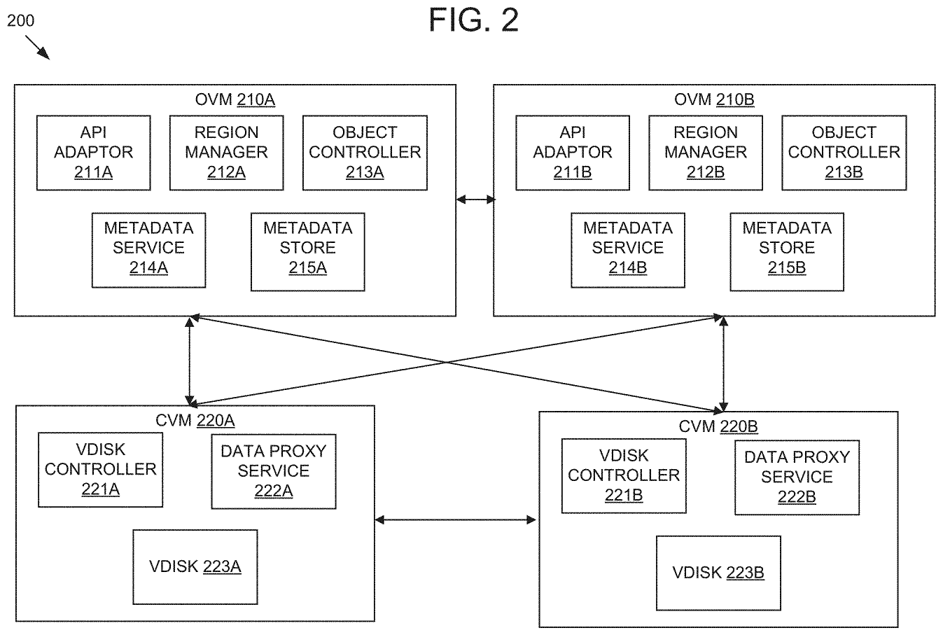

Referring now to FIG. 2, an example embodiment of an object storage environment 200 for writing and reading objects is shown. In brief overview, the object storage environment 200 includes an object virtual machine (OVM) 210A, an OVM 210B, a controller virtual machine (CVM) 220A, and a CVM 220B. The OVM 210A may include an application programming interface (API) adaptor 211A, a region manager 212A, an object controller 213A, a metadata service 214A, and a metadata store 215A. Similarly, the OVM 210B may include an API adaptor 211B, a region manager 212B, an object controller 213B, a metadata service 214B, and a metadata store 215B. The OVMs 210A and 210B may be instances of the OVM 111A with respect to FIG. 1. The OVMs 210A and 210B may form an OVM cluster or may form separate OVM clusters. The OVMs 210A and 210B may be hosted on the same node or on different nodes.

The CVM 220A includes and/or hosts, a vdisk controller 221A, a data proxy service 222A, and a vdisk 223A. Similarly, the CVM 220B includes and/or hosts a vdisk controller 221B, a data proxy service 222B, and a vdisk 223B. The CVMs 220A and 220B may be instances of the CVM 115A with respect to FIG. 1. The CVMs 220A and 220B may form a NOS cluster or may form separate NOS clusters. Each of the CVMs 220A and 220B may be hosted on the same node as one or more of the OVMs 210A and 210B or on a different node. Although two OVMs and two CVMs are shown in the object storage environment, in other embodiments, greater than or fewer than two OVMs and/or two CVMs may be used.

Without loss of generality, functionality of components of the OVMs (e.g. the API adaptor 211A, the region manager 212A, the object controller 213A, the metadata service 214A, and the metadata store 215A) is described with respect to the OVM 210A. Likewise, without loss of generality, functionality of components of the CVMs (e.g. the vdisk controller 221A, the data proxy service 222A, and the vdisk 223A) is described with respect to the CVM 220A.

Each of the elements or entities of the virtual computing system 100 and the object storage environment 200 (e.g. the OVM 210A, the API adaptor 211A, the region manager 212A, the object controller 213A, the metadata service 214A, the metadata store 215A, the CVM 220A, the vdisk controller 221A, the data proxy service 222A, and the vdisk 223A), is implemented using hardware or a combination of hardware or software, in one or more embodiments. For instance, each of these elements or entities can include any application, program, library, script, task, service, process or any type and form of executable instructions executing on hardware of the virtual computing system 100 and/or the object storage environment 200. The hardware includes circuitry such as one or more processors (e.g. the CPU 130A) in one or more embodiments. Each of the one or more processors is hardware. The OVM 210A, the API adaptor 211A, the region manager 212A, the object controller 213A, the metadata service 214A, the metadata store 215A, the CVM 220A, the vdisk controller 221A, the data proxy service 222A, the vdisk 223A, or a combination thereof may be an apparatus including a processor having programmed instructions. The instructions may be stored on one or more computer readable and/or executable storage media including non-transitory storage media such as non-transitory storage media in the storage pool 140 with respect to FIG. 1.

The API adaptor 211A may include a processor having programmed instructions (hereinafter, the API adaptor 211A may include programmed instructions) to communicate with OSS clients, interpret requests, and perform necessary validation before sending the request to, for example, the object controller 213. The API adaptor 211A may include programmed instructions) to support representational state transfer (REST) API. The client may be a user, an application, or any client that uses REST API. The client may use the REST API to create or close a bucket, or read or write an object to the bucket, among others. The API adaptor 211A may include programmed instructions to translate a read and/or write request from the client to an object controller call. The object controller call may be in accordance with a block storage protocol (e.g. iSCSI, SCSI, or SAN), a file storage protocol (e.g. NFS) or an HTTP API (e.g. REST). In some embodiments, the API adaptor 211A includes programmed instructions to receive data as part of the read and/or write request. In some embodiments, after the request is served by the other components of the object layer and the storage layer, the API adaptor 211A responds to the client, for example, in the REST API protocol.

In some embodiments, the API adaptor 211A includes programmed instructions to perform authentication and authorization. For example, in response to a client requesting access and/or sending identifiable information (e.g. a location, a datacenter identifier, a tenant identifier, an IP address, a MAC address, a username, or a password), the API adaptor 211A can generate a token that expires after a predetermined amount of time. The API adaptor 211A can send the token to the client. The client can thereinafter include the token in any read and/or write request. When the token expires, the client can renew access to the OSS.

The region manager 212A may include a processor having programmed instructions (hereinafter, the region manager 212A may include programmed instructions) to receive and serve bucket requests from a client, via the API adaptor 211A, including requests to create, open, read, update, close, and delete. For example, the region manager 212A may receive a client request to create a bucket. Responsive to receiving the bucket create request, the region manager 212A may include programmed instructions to allocate regions from one or more vdisks and assign the regions to an owner bucket. In some embodiments, the vdisks are shared by buckets. The region manager 212A may send a request to a metadata service (e.g. the metadata service 214B) to create a data structure in which the vdisk is mapped to the owner bucket. The metadata service selected by the region manager 212A may be a metadata service that created a data structure for storing metadata corresponding to the bucket. In some embodiments, the region manager 212A may create the data structure and store it in an local memory (e.g. cache or RAM) and send the data structure to the metadata service responsive a pre-determined trigger, such as identifying the metadata service that is responsible for the bucket or determining that the data structure is finalized.

The region manager 212A may include programmed instructions to receive a request from the object controller 213A to provide metadata associated with an object. The object may reside in a bucket created by the region manager 212A. The region manager 212A may include programmed instructions to fetch the metadata associated with the object from a metadata service serving the object (e.g. the metadata service 214B) and store it in cache or RAM associated with the region manager 212A.

The object controller 213A may include a processor having programmed instructions (hereinafter, the object controller 213A may include programmed instructions) to receive and serve object requests (first requests) from a client, via the API adaptor 211A, including requests to create, read, update, and delete. For example, the object controller 213A may receive a client request to write to (e.g. update) an object. The object controller 213A may include programmed instructions to store any data associated with the client request in memory. The memory may on the node that is hosting the object controller 213A. The memory may be physical or virtual. In some embodiments, the object controller 213A maintains a checksum for the object data. In some embodiments, the object controller 213A computes an MD5sum of the data. In some embodiments, the object controller 213A allocates space, or causes the region manager 212A to allocate space, from the NOS backend. The allocated space may be a vdisk or a region. In some embodiments, the object controller 213A sends the data to the NOS for writing to a vdisk.

In some embodiments, the client write request is for an object that already has metadata associated with it in a metadata service. The object controller 213A may send a first request to a metadata service local to the object controller 213A (e.g. the metadata service 214A) to identify a metadata service (e.g. the metadata service 214B) that is serving the object metadata associated with the write request. In some embodiments, the serving metadata service is a metadata service that is assigned to the object or the bucket that the object resides on. In some embodiments, the serving metadata service is a metadata service that created a data structure for storing metadata corresponding to the object or the bucket that the object resides on. In some embodiments, the object controller 213A may send the a second request for identifying the serving metadata service to the local region manager (e.g. the region manager 212A). The second request may a part of the client request forwarded from the object controller 213A. In some embodiments, an instance of metadata service may run inside the local region manager.

In some embodiments, the object controller 213A writes the object data to a NOS location where previous data associated with the object is stored. The object controller 213A may include programmed instructions to identify the vdisk where the object associated with the write request is located. The object controller 213A may include programmed instructions to send a third request to the serving metadata service to read metadata of the object associated with the write request. The metadata may include the location of the vdisk where the object associated with the write request is located. The location may include an identifier of which node the vdisk is located on. The location may include a location of a sub-block within the vdisk where the next write is to be appended. The sub-block may be specified by an offset. The third request may a part of the client request forwarded from the object controller 213A.

In some embodiments, the object controller 213A populates metadata and writes to a metadata server (e.g. the metadata service 214A and/or the metadata store 215A). The metadata may include an object handle, an object key, an object key-value pair, a vdisk location and/or identifier, and/or a physical disk location and/or identifier, among others. The handle may include one or more object parameters or a concatenation of object parameters. The object parameters can be received from the client or from a component in the OVM 210A. The object parameters may include an object identifier, a bucket identifier, a bucket partition identifier, the number of bucket partitions, and/or a requested version of the object. The object controller 213A may generate a key by hashing the handle. In some embodiments, the key is an index. In some embodiments, the key and/or the index may correspond to a metadata entry of the object (i.e. the metadata entry can be found at the index of an array).

In some embodiments, the object controller 213A requests to create or add a metadata entry associated with an object previously written to the NOS. The metadata entry of the object may reside in a metadata store such as the metadata store 215A. The index of the metadata entry may include object parameters including the object parameters received by the object controller 213A and other object parameters such as a metadata service responsible for the object, a vdisk (and an offset) where object data of the object is written, a physical disk (and an offset) where the object data of the object is written, and/or a timestamp of when the object was last updated. In some embodiments, after the write request is complete and the metadata is populated and stored in a metadata server, the object controller 213A responds to the client request forwarded and/or interpreted by the API adaptor 211A.

The object controller 213A may include programmed instructions to receive a client request, or generate a request, to read an object. The object controller 213A may include programmed instructions to send the request to a CVM (e.g. CVM 220A) or a vdisk controller (e.g. the vdisk controller 221A) in the CVM. The CVM may be local to the vdisk associated with the client object write request (e.g. the local CVM is the CVM hosted on the same node as the vdisk). The request may be to write the object, including object data and/or metadata. The CVM may serve the write request by writing the object to the vdisk. The request may be an API request. In some embodiments, the API write request includes write attributes such as a level of priority for the write, a type of write to be performed, or the physical disk location. The priority level may be low or high, for example. The type of write may be a sequential write or a random write. The write attributes directly affect the physical storage of the object. Thus, the object controller leverages API writes to expose storage level functionality of a different node, cluster, or datacenter to the object layer (e.g. the OVM 210A).

The object controller 213A may include programmed instructions to receive, from the CVM, a location of a physical disk where the object data may be subsequently read from. The object controller 213A may include programmed instructions to store and/or send an update of the location of the physical disk and/or the vdisk to the serving metadata service. The location of the physical disk and/or the vdisk may be stored in the data structure for storing metadata corresponding to the object associated with the write request. The object controller 213A may communicate with the CVM using a block storage protocol (e.g. iSCSI, SCSI, or SAN), a file storage protocol (e.g. NFS), or REST API.

The object controller 213A may include programmed instructions to receive a client request, or generate a request, to read an object. The object controller 213A may include programmed instructions to send an object identifier associated with the object to request to the serving metadata service. The object controller 213A or the metadata service 214A may include programmed instructions to look up the physical location disk in a data structure in the metadata store using the physical disk. The object controller 213A may include programmed instructions to receive the physical disk location from the metadata service 214A. The object controller 213A may include programmed instructions to send the request to a CVM local to the physical disk and/or the vdisk (e.g. hosted on the same node as the physical disk and/or the vdisk) to read the object data. The object controller 213A may include programmed instructions to send the location of the physical disk and/or the vdisk to the CVM local to the physical disk and/or the vdisk. The object controller 213A may include programmed instructions to receive the object data associated with the read request from the CVM local to the physical disk and/or the vdisk.

The metadata service 214A may be configured as an interface between the region manager 212A and the metadata store 215A. The metadata service 214A may include a processor having programmed instructions (hereinafter, the metadata service 214A may include programmed instructions) to create, update, or delete buckets. The metadata service 214A may include programmed instructions to determine if a bucket with a same name exists. For a create bucket request, in response to determining that no bucket with the same name exists, the metadata service 214A may include programmed instructions to calculate a set of bucket partitions and vdisks associated with the partitions. The metadata service 214A may include programmed instructions to maintain a fixed range offset associated with each of the bucket partitions.

The metadata service 214A may include programmed instructions to identify the metadata service (e.g. metadata service 214B) that is serving the object. The serving metadata service 214 may include programmed instructions to serve a request from the object controller 213A to read or update object metadata of the object. Reading object metadata may including sending a location of the vdisk and/or physical disk to the object controller 213A. The serving metadata service may include programmed instructions to find the object metadata in a metadata entry corresponding to an index received from the object controller 213A.

The metadata store 215A is a log-structured-merge (LSM) based key-value store including key-value data structures in memory and persistent storage. The data structures may be implemented as indexed arrays including metadata entries and corresponding indices. The indices may be represented numerically or strings. Each metadata entry include key-value pair including a key and one or more values. The key may be a hash of an object handle associated with an object whose metadata is stored in the metadata entry. The object handle may include the object identifier, the bucket identifier, the bucket partition identifier, the number of bucket partitions, the requested version of the object, a metadata service responsible for the object, a vdisk (and an offset) where object data of the object is written, a physical disk (and an offset) where the object data of the object is written, and/or a timestamp of when the object was last updated.

The vdisk controller 221A may configured to receive instructions to write or read object data from an object controller 213A. The vdisk controller 221A may include a processor having programmed instructions (hereinafter, the vdisk controller 221A may include programmed instructions) to translate the instructions to block storage format (e.g. SAN or iSCSI). The vdisk controller 221A may include programmed instructions to write data to or read data from a vdisk 223A. The data proxy service 222A may include a processor having programmed instructions to read data from a remote vdisk (e.g. vdisk 223B).

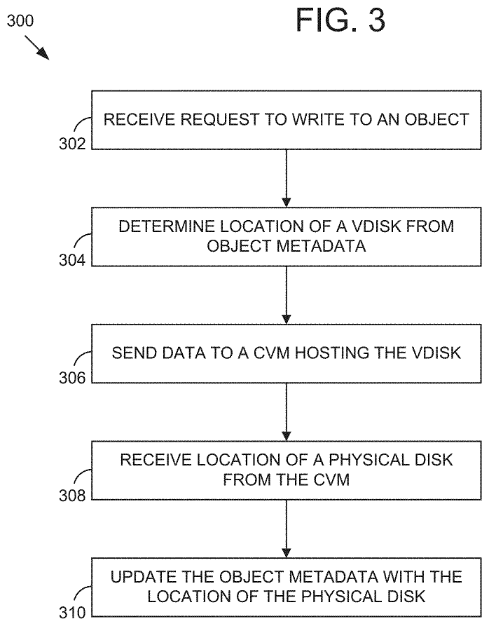

Referring now to FIG. 3, an example method 300 for serving an object write request is shown. The method 300 for serving an object write request may be implemented using, or performed by, one or more of the components of the virtual computing system 100 and/or the object storage environment 200, both of which are detailed herein with respect to FIG. 1 and FIG. 2. The method 300 for serving an object write request may be implemented using, or performed by, the object controller 213A, or a processor associated with the object controller 213A. Additional, fewer, or different operations may be performed in the method 300 depending on the embodiment.

At operation 302, an object controller, such as the object controller 213A, receives a request to write to an object. In some embodiments, the write request is an API request. In some embodiments, the object controller may identify a metadata service, such as the metadata service 214B, serving metadata of the object associated with the write request. At operation 304, the object controller determines the location of a vdisk, such as the vdisk 223A, assigned to the object from the object metadata. In some embodiments, the object controller determining the location includes sending a request for the vdisk location to the serving metadata service. In some embodiments, determining the location includes determining a node that is hosting the vdisk and determining an offset location on the vdisk on which to append data associated with the write request. At operation 306, the object controller sends a second write request, including data to be written, to a CVM hosting the vdisk, such as the CVM 220A, causing the CVM to write the data to the vdisk. In some embodiments, the second write request is an API request. In some embodiments, the second write request is the first write request. At operation 308, the object controller receives, from the CVM, in a response to the second write request, a location of the physical disk where the data is physically stored and/or the virtual disk where the data is virtually stored. At operation 310, the object controller sends or forwards the location of the physical disk and/or the virtual disk to a metadata store or updates the object metadata in the metadata store with the location of the physical disk and/or the virtual disk. In some embodiments, the location of the physical disk is stored in a data structure in the metadata store.

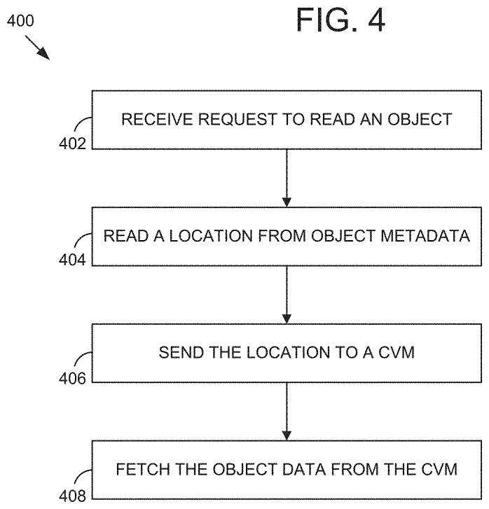

Referring now to FIG. 4, an example method 400 for serving an object read request is shown. The method 400 for serving an object read request may be implemented using, or performed by, one or more of the components of the virtual computing system 100 and/or the object storage environment 200, both of which are detailed herein with respect to FIG. 1 and FIG. 2. The method 400 for serving an object read request may be implemented using, or performed by, the object controller 213A, or a processor associated with the object controller 213A. Additional, fewer, or different operations may be performed in the method 400 depending on the embodiment. The method 400 may be viewed as a stand-alone method or as part of a bigger method including the method 300.

At operation 402, an object controller, such as the object controller 213A, receives a request to read an object. In some embodiments, the request to read an object is subsequent to serving, by the object controller, a request to write to the object as described with respect to FIG. 3. At operation 404, the object controller reads a location of the object form metadata of the object. In some embodiments, reading the location includes reading a location of a vdisk, such as the vdisk 223A, and/or reading a location of the physical disk where the data of the object is stored. In some embodiments, reading the location includes reading the location from a serving metadata service, such as the metadata service 214B. At operation 406, the object controller sends the location to a CVM, such as the CVM 220A. In some embodiments, using the physical disk location, the object controller sends an API read request to the CVM on a same node as the physical disk. Using the physical disk location may include mapping the physical disk location to the CVM on the same not as the physical disk. At operation 408, the object controller fetches the object data located at the location specified by the object metadata.

### Efficient Pipelining in an Object Storage System

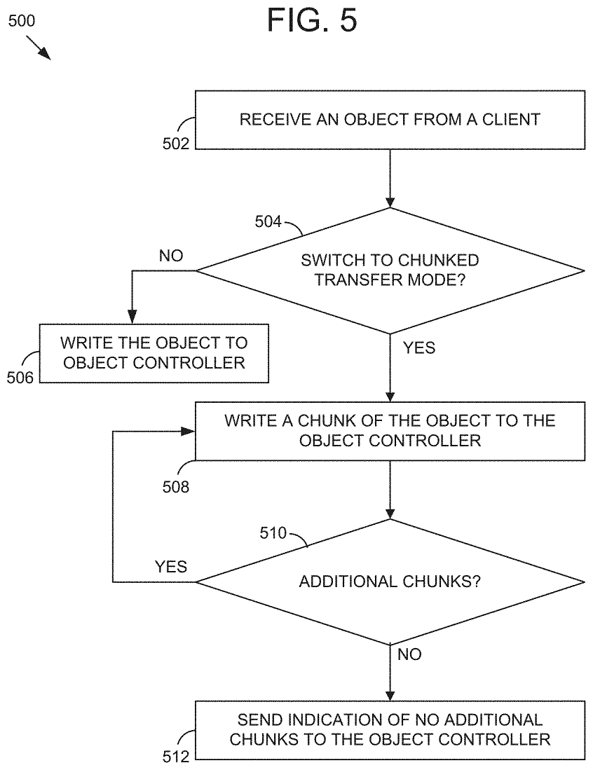

Referring now to FIG. 5, an example method 500 for pipelining is shown. The method 500 for pipelining may be implemented using, or performed by, one or more of the components of the virtual computing system 100 and/or the object storage environment 200, both of which are detailed herein with respect to FIG. 1 and FIG. 2. The method 500 for pipelining may be implemented using, or performed by, the API adaptor 212A, or a processor associated with the API adaptor 212A. Additional, fewer, or different operations may be performed in the method 500 depending on the embodiment. The method 500 may be viewed as a stand-alone method or as part of a bigger method including the method 300 and/or the method 400.

The API adaptor receives an object from a client, via a network (502). In some embodiments, the object arrives as part of a PUT header. The API adaptor determines whether to switch to chunked transfer mode (504). In chunked transfer mode, the API adaptor sends the object to the object controller in “chunks” (e.g. 1 MB chunks). The API adaptor may determine to switch to chunked transfer mode responsive to determining that a size of the object satisfies a predetermined threshold (e.g. greater than 1 GB). Responsive to determining that the object size does not satisfy the predetermined threshold, the process proceeds to 506. The API adaptor writes the object to an object controller (506). Otherwise, responsive to determining that the object size does satisfies the predetermined threshold the process 500 proceeds to 508. In some embodiments, before proceeding to 508, the API adaptor partitions the object into chunks. In some embodiments, the API adaptor determines a size of each chunk. In some embodiments, the chunk size is a uniform size (e.g. applies to all of the chunks). In some embodiments, the size determination is based on the client, a policy, or a function of the needed and/or available resources for sending and/or storing the chunk.

The API adaptor writes a chunk of the object to an object controller (508). In some embodiments, upon receiving the chunk, the object controller reads the chunk and/or stores the chunk in memory. In some embodiments, the object controller performs the necessary allocations for storage on NOS. In some embodiments, the object controller computes a MD5Sum for the chunk. In some embodiments, the API adaptor first creates a data transfer manager on the object controller, which manages the entire state of the transfer. In some embodiments, the object controller writes the chunk to the NOS (e.g. a CVM and/or vdisk controller running on the CVM) at the pre-allocated location. In some embodiments, the NOS reads the chunk over network and writes to the underlying storage. In some embodiments, once the chunk is written to and/or stored in the underlying storage, the call returns back to object controller and the object controller returns the callback to the API Adapter.

The API adaptor determines whether the object includes additional chunks (510). Responsive to determining that the object includes additional chunks, the process proceeds to 508. Otherwise, the process 500 proceeds to 512. The API adaptor can sends an indication to the object controller that there are no additional chunks to store (512). In some embodiments, once the object controller receives the indication, the object controller can finalize the metadata and writes to a metadata server. In some embodiments, the call then returns back to the API Adapter. In some embodiments, the API Adapter then sends the call back to the client thereby completing the original object request from the client to the API adaptor.

In some embodiments, some of the network I/O stages of pipelining are overlapping. In some embodiments, the object controller responds back immediately to the caller after reading the chunk and in the background spawns a background job to compute MD5Sum of the chunk and write the chunks to the NOS. In some embodiments, the API adaptor, upon receiving the response from the object controller, reads the next chunk and sends it to the object controller. In some embodiments, a CPU based activity (e.g. calculating the MD5Sum) and a Disk IO activity (e.g. writing to a virtual disk and/or HDD storage) can be performed concurrently.

In some embodiments, multiple chunks can be written concurrently. In some embodiments, the object controller, via the CVM, can send multiple requests to write chunks to the underlying storage even though the previous requests have not finished. In some embodiments, the MD5sum is calculated sequentially, but disk IOs to NOS are performed concurrently.

### Shadow Buckets and Multipart Upload

In some embodiments, one or more components of the object storage environment 200 (e.g. the object controller 213A) can create shadow buckets. Shadow buckets are configured to store objects such that the objects are hidden from the client. Shadow buckets can be used for multi-part object or composed object uploads/writes and/or reads.

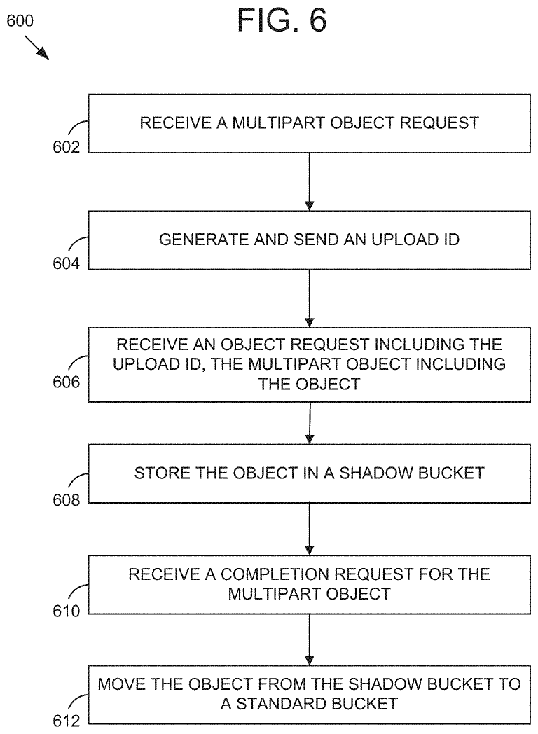

Referring now to FIG. 6, an example method 600 for uploading objects using shadow buckets is shown. The method 600 for uploading objects using shadow buckets may be implemented using, or performed by, one or more of the components of the virtual computing system 100 and/or the object storage environment 200, both of which are detailed herein with respect to FIG. 1 and FIG. 2. The method 600 for uploading objects using shadow buckets may be implemented using, or performed by, the OVM 210A, the processor associated with the OVM 210A, the object controller 213A, or a processor associated with the object controller 213A. Additional, fewer, or different operations may be performed in the method 600 depending on the embodiment. The method 600 may be viewed as a stand-alone method or as part of a bigger method including the method 300 and/or the method 400.

An object store (e.g. an OVM, an API adaptor, or an object controller, among others) receives a first request to initiate an upload of a multipart object (602). The first request can be from a client. The first request can include an API call such as a PUT or POST. The object store (e.g. the object controller) generates a unique upload identifier (604). In some embodiments, the object controller creates a special metadata object by concatenating a bucket identifier (ID) with the upload ID. This way, for each object request relating to the multipart upload request, the object controller can quickly retrieve the corresponding metadata. In some embodiments, the bucket identifier is associated with a shadow bucket that objects of the multipart object are to be stored in. The object store returns the unique upload ID and/or the special metadata object to the client.

The object store receives a request to upload one or more objects (606). Each of the one or more objects is a part of the multipart object and is associated with a part number and a part length. The request can include the one or more objects, the upload ID, the corresponding part numbers, and the corresponding part lengths. In some embodiments, the object store returns an entity tag (ETAG), such as an MD5sum of the part that has been uploaded, in the response, for each part. For each object the client sends to the object store, in some embodiments, the API adaptor generates the MD5sum and forward the object to the object controller. In some embodiments, the object controller looks up the metadata for the upload.

The object store (e.g. the object controller) writes the one or more uploaded objects to a shadow bucket (608). The shadow bucket can be associated with a region or a vdisk. In some embodiments, storing the objects on the shadow bucket causes the objects to be hidden from the client. In some embodiments, the object store records, saves, or otherwise stores a tuple (e.g. the part number, a vdisk ID and/or a shadow bucket ID, a vdisk offset, the part length, and the MD5sum) in a metadata entry, in a metadata server/store, corresponding to each of the one or more object uploads.

The object store receives a completion request for the multipart object (610). In some embodiments, the completion request includes a list of the uploaded objects (e.g. the objects that are a part of the multipart object) received by the object store along with their corresponding ETAG values. In some embodiments, the object controller finalizes the multipart object by creating and/or updating a multipart object information (info) entry corresponding to the multipart upload and update a list map. The multipart object info for this object will contain a vector of tuples (e.g. a start offset, a length, a vdisk ID, and a vdisk offset).

The object store moves the object from the shadow bucket into a standard bucket (612). The standard bucket can be associated with a region or a vdisk. In some embodiments, moving the one or more objects to the standard bucket causes the one or more objects to be visible to the client. The object controller can delete each of the metadata entries corresponding to the one or more objects that are a part of the multipart object. Alternatively or additionally, the object controller can recreate the multipart object from its individual parts.

In some embodiments, the client can choose terminate the multipart upload. In some embodiments, the object store can delete all the parts and garbage collect the space. In some embodiments, the object store can generate a list of upload parts and/or concurrent multipart uploads that are in progress (e.g. not yet completed or aborted). For the list parts operation, object controller can read the parts vector in the metadata entry and return the list of the parts that have been sent by the client.

It is to be understood that any examples used herein are simply for purposes of explanation and are not intended to be limiting in any way.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed:

1. An apparatus comprising a processor having programmed instructions to:
send an application programming interface (API) write request to a first virtual machine (VM) on a first node to write an object;
receive a response to the API write request including a physical disk location of a physical disk to which the object is written, wherein the physical disk is located on a second node; and
using the physical disk location, send an API read request to a second VM on the second node to read the object.

2. The apparatus of claim 1, the processor having further programmed instructions to:
forward the physical disk location to a data structure in a metadata store; and
responsive to receiving the API read request, look up the physical disk location in the data structure associated in the metadata store.

3. The apparatus of claim 2, the processor having further programmed instructions to identify a metadata service on a same node as the metadata store.

4. The apparatus of claim 1, the processor having programmed instructions to look up a virtual disk location of a virtual disk associated with an object handle received from a client, wherein the API write request includes the virtual disk location.

5. The apparatus of claim 1, the processor having programmed instructions to hash an object handle received from a client to create a key, wherein the API write request includes the key.

6. The apparatus of claim 1, wherein the API write request includes a level of priority.

7. The apparatus of claim 1, wherein the API write request includes a type of write, wherein the type of write includes a sequential write or a random write.

8. The apparatus of claim 1, the processor having further programmed instructions to:
determine that a size of the object exceeds a predetermined threshold;
partition the object into a plurality of chunks; and
write one of the plurality of chunks to the VM.

9. The apparatus of claim 1, wherein the object is part of a multipart object, and wherein the processor having further programmed instructions to:
write the object to a shadow bucket, causing the object to be hidden;
receive a completion request for the multipart object; and
move the object from the shadow bucket to a standard bucket, causing the object to be visible.

10. A non-transitory computer readable storage medium having instructions stored thereon that, upon execution by a processor, causes the processor to perform operations comprising:
sending an application programming interface (API) write request to a first virtual machine (VM) on a first node to write an object;
receiving a response to the API write request including a physical disk location of a physical disk to which the object is written, wherein the physical disk is located on a second node; and
using the physical disk location, sending an API read request to a second VM on the second node to read the object.

11. The storage medium of claim 10, the operations further comprising:
forwarding the physical disk location to a data structure in a metadata store; and
responsive to receiving the API read request, looking up the physical disk location in the data structure associated in the metadata store.

12. The storage medium of claim 11, the operations further comprising identifying a metadata service on a same node as the metadata store.

13. The storage medium of claim 10, the operations further comprising looking up a virtual disk location of a virtual disk associated with an object handle received from a client, wherein the API write request includes the virtual disk location.

14. The storage medium of claim 10, the operations further comprising hashing an object handle received from a client to create a key, wherein the API write request includes the key.

15. The storage medium of claim 10, wherein the API write request includes a level of priority.

16. The storage medium of claim 10, wherein the API write request includes a type of write, wherein the type of write includes a sequential write or a random write.

17. A computer-implemented method comprising:
sending, by a processor, an application programming interface (API) write request to a first virtual machine (VM) on a first node to write an object;
receiving, by the processor, a response to the API write request including a physical disk location of a physical disk to which the object is written, wherein the physical disk is located on a second node; and
using the physical disk location, sending, by the processor, an API read request to a second VM on the second node to read the object.

18. The method of claim 17, further comprising:
forwarding, by the processor, the physical disk location to a data structure in a metadata store; and
responsive to receiving the API read request, looking up, by the processor, the physical disk location in the data structure associated in the metadata store.

19. The method of claim 18, further comprising identifying, by the processor, a metadata service on a same node as the metadata store.

20. The method of claim 17, further comprising looking up, by the processor, a virtual disk location of a virtual disk associated with an object handle received from a client, wherein the API write request includes the virtual disk location.

21. The method of claim 17, further comprising hashing, by the processor, an object handle received from a client to create a key, wherein the API write request includes the key.

22. The method of claim 17, wherein the API write request includes a level of priority.
